(19) United States
(12) Patent Application Publication
(10) Pub. No.: US 2021/0129527 A1
(43) Pub. Date: May 6, 2021

(54) DELAY DEVICES

(71) Applicant: HEWLETT-PACKARD DEVELOPMENT COMPANY, L.P., Spring, TX (US)

(72) Inventors: James Michael GARDNER, Corvallis, OR (US); Scott A. LINN, Corvallis, OR (US)

(73) Assignee: HEWLETT-PACKARD DEVELOPMENT COMPANY, L.P., Spring, TX (US)

(21) Appl. No.: 16/959,068

(22) PCT Filed: Feb. 6, 2019
(86) PCT No.: PCT/US2019/016747

§ 371 Date: Jun. 29, 2020

(51) Int. Cl. B41J 2/045

(52) U.S. Cl. CPC B41J 2/04573; B41J 2/04543; B41J 2/04541

(57) ABSTRACT

An integrated circuit to drive fluid actuators is disclosed. The integrated circuit includes delay circuits coupled in series and to a fire input to receive a fire signal in succession. Each delay circuit receives the fire signal and, after a delay, provides the fire signal via an output to a corresponding fluid actuator. A programmable frequency generator is coupled to each of the of delay circuits. The programmable frequency generator provides a clock signal having an adjustable frequency to control the delay.

### BACKGROUND

Printing devices can include printers, copiers, fax machines, multifunction devices including additional scanning, copying, and finishing functions, all-in-one devices, or other devices such as pad printers to print images on three dimensional objects and three-dimensional printers (additive manufacturing devices). In general, printing devices apply a print substance often in a subtractive color space or black to a medium via a device component generally referred to as a printhead. Printheads can employ fluid actuator devices, or simply actuator devices, to selectively eject droplets of print substance onto a medium during printing. For example, actuator devices can be used in inkjet type printing devices. A medium can include various types of print media, such as plain paper, photo paper, polymeric substrates and can include any suitable object or materials to which a print substance from a printing device are applied including materials, such as powdered build materials, for forming three-dimensional articles. Print substances, such as printing agents, marking agents, and colorants, can include toner, liquid inks, or other suitable marking material that in some examples may be mixed with other print substances such as fusing agents, detailing agents, or other materials and can be applied to the medium.

### BRIEF DESCRIPTION OF THE DRAWINGS

FIG. 1 is a block diagram illustrating an example integrated circuit, which can be used to drive a plurality of actuators.

FIG. 2 is a block diagram illustrating an example fluid ejection device that can include the example integrated circuit of FIG. 1.

FIG. 3 is a schematic diagram illustrating an example printing device that can include the example fluid ejection device of FIG. 2.

### DETAILED DESCRIPTION

An inkjet printing system, which is an example of a fluid ejection system, can include a printhead, a print substance supply, and an electronic controller. The printhead, which is an example of a fluidic actuator device or actuator device, can selectively pump a fluid, such as eject droplets of print substance, through a plurality of nozzle assemblies, of which each nozzle assembly can be an example of an actuator, onto a medium during printing. Each nozzle assembly can include a resistor or piezo element to pump fluid through a nozzle or fluid channel. The nozzles of the nozzle assemblies can be arranged on the printhead in a column or an array and the electronic controller can selectively sequence ejection of print substance. The printhead can include hundreds or thousands of actuators, and each actuator ejects a droplet of print substance in a firing event in which electrical power and actuation signals are provided to printhead. Each actuator can consume tens of milliamperes (mA) of current during a firing event. The amount of electrical power required to simultaneously fire all actuators on the printhead can exceed a current limit of the printing device, which can reduce print quality or cause substantial damage to the printhead.

Consequently, printheads often stagger the firing events to reduce peak power consumption during printing. Printheads typically employ delay circuits having flip-flops driven with a continuously running clock signal to stagger the firing events. The clock signal can be received from an external source, such as the electronic controller, and coupled to the printhead via vires, traces, or contact pads. In one example, the printhead is configured to receive the external clock signal and stagger the firing events in the order of 100 nanoseconds apart. Each firing event can be triggered with a fire signal provided to each actutaor. The fire signal is provided from the delay circuit that may include a logic high, or a signal driven to a selected voltage, for approximately a microsecond to trigger the firing event or actuate the actuator. Rather than simultaneously actuate hundreds or thousands of actuators, the delay circuits may simultaneously actuate a dozen or so actuators and substantially reduce peak current consumption, extend printhead life, as well as increase print efficiency.

As printheads and associated circuits get smaller, several circuit architectures are changed. These architecture adaptations have affected how the actuators are fired and how the firing events are staggered. Reductions to power routing and circuit area, however, reduce the peak currents that can be tolerated by a printhead die. Certain circuit architectures may not have the geometries to receive an external clock signal. Further, external clock signals are generally tuned to system parameters because the external clock signals are often used to drive multiple circuits in addition to the delay circuits. Thus, the amount of stagger between firing events is dependent on the number of flip-flops used in the delay circuits.

This disclosure is directed to an integrated circuit having a series of programmable delay elements that can stagger the fire signals provided to the fluid actuators. In one example, a fluid ejection device includes a first actuator and a second actuator that selectively eject a print substance in response to a fire signal. A first delay element is operably coupled in series with logic to receive the fire signal and a second delay element. The first delay element receives the fire signal and provides the fire signal to a first output after delay. The first output is coupled to the first actuator and the second delay element. The second delay element receives the fire signal from the first output and provides the fire signal to a second output after delay. The second output is operably coupled to the second actuator. An on-die programmable frequency generator is coupled to the first and second delay circuits to adjust the delay.

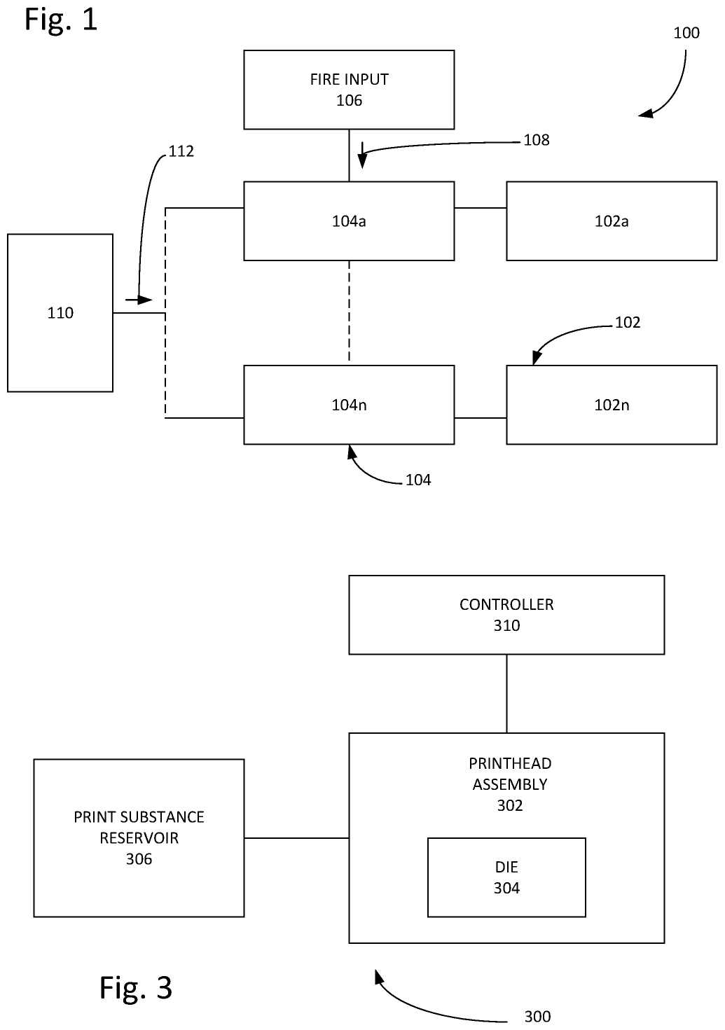

FIG. 1 illustrates an example of an integrated circuit 100 to drive a plurality of fluid actuators 102. The plurality of fluid actuators 102 can include fluid actuators 102a . . . 102n. The integrated circuit 100 includes a plurality of delay circuits 104, including delay circuits 104a . . . 104n. Each of the delay circuits 104a . . . 104n produces an output waveform similar to its input waveform but delayed by a selected amount of time. The plurality of delay circuits 104 are coupled together in series and to a fire input 106 to receive a fire signal 108. Each of the of the delay circuits 104a . . . 104n of the plurality of delay circuits 104 receives the fire signal 108, and after a delay, provides the fire signal 108 via an output 114a . . . 114n of a plurality of outputs 114 to a corresponding fluid actuator 102a . . . 102n to trigger or actuate a firing event in the fluid actuator 102a . . . 102n. For example, a delay circuit of the plurality of delay circuits 104 is coupled in series to a successive delay circuit of the plurality of delay circuits 104. The delay circuit receives the fire signal 108, and after a local delay, provides the fire signal 108 to a corresponding fluid actuator of the plurality of fluid actuators 102 and to the successive delay circuit. The successive delay circuit receives the fire signal 108, and, after a local delay provides the fire signal 108 to a corresponding fluid actuator of the plurality of fluid actuators 102. In one example, the fire signal 108 is a waveform having a logic voltage, such as a logic high voltage between about 1.8 volts and 15 volts, for a selected amount of time, such as 1 microsecond, to actuate a fluid actuator of the plurality of fluid actuators 102.

The integrated circuit 100 includes a programmable frequency generator 110 operably coupled to each of the delay circuits 104a . . . 104n. The programmable frequency generator 110 provides a clock signal 112 at a selected frequency to each of the delay circuits 104a . . . 104n to control the delay. In one example, the clock signal 112 can be an oscillating voltage signal that provides an amount of delay via the frequency in each of the delay circuits 104a . . . 104n to the fire signal 108 prior to the fire signal 108 provided at the output 114a . . . 114n. The frequency of the clock signal 112 provided to the delay circuits 104 can be selected from a plurality of available frequencies that can be generated by the programmable frequency generator 110. In this example, a length of the delay in a delay circuit 104 is variable. Each frequency of the plurality of frequencies of clock signals that can be provided to the delay circuits 104 can provide a different amount of delay in the delay circuits 104. In one example, a single frequency clock signal 112 can be output from the programmable frequency generator 110, but that single frequency of the clock signal 112 can be selected from a plurality of available frequencies that can be generated by the programmable frequency generator 110. The programmable frequency generator 110 can programmably adjust a frequency provided as the clock signal 112, which can affect a length of the delay of the delay circuits 104a . . . 104n.

The delay circuits 104 are characterized by producing an output waveform similar to the input waveform, such as an input fire signal 108, but locally delayed by a selected amount of time. In general, this selected amount of time is variable and is based upon a selected frequency or clock period of the input clock signal. For instance, a first frequency or first clock period provides a first amount of delay in the delay circuits 104, and a second frequency or second clock period, which is different than the first frequency or first clock period, provides a second amount of delay in the delay circuits 104 that is different than the first amount of delay. Example delay circuits 104 can employ bistable multivibrators, such as a flip-flop or digital timer circuits. In some examples, a delay circuit 104 can be configured from cascaded delay circuit elements, such as cascaded flip-flops. An output of a delay circuit having a flip-flop is provided as an input of a successive flip-flop in a successive delay circuit.

In one example, a delay circuit 104 can be configured from a D flip-flop, which can be referred to as a “data” flip flop or “delay” flip-flop. A D flip-flop includes a D-input and a clock signal input. The D-input can be configured to receive the input fire signal 108. The clock signal input can be configured to receive the clock signal 112. The D flip-flop captures the value of the D-input, or fire signal 108, at a definite portion of the clock cycle such as the rising edge of the clock signal 112. The captured value becomes the Q output, but at other times, the output Q does not change. The output Q provides the fire signal 108 via an output 114a . . . 114n of a plurality of outputs 114 to a corresponding fluid actuator 102a . . . 102n to trigger or actuate a firing event in the fluid actuator 102a . . . 102n. The output Q is also provides the fire signal to the D-input of the successive D flip-flop.

The programmable frequency generator 110 provides an on-die production of the clock signal 112 supplied to the delay elements 104. The programmable frequency generator 110 can include an electronic oscillator, such as a ring oscillator or resistor-capacitor (RC) oscillator or timer, to generate an output that alternates between two voltage levels as the clock signal 112. In one example, a nominal clock period of the clock signal 112 is approximately 100 nanoseconds, which permits the programmable frequency generator 110 to consume a relatively small amount of area of the integrated circuit 100. In one example, the clock period of the clock signal 112 can be adjustably programmed or selected with the programmable frequency generator 110 to adjust, or maintain, a clock frequency provided to the delay circuits 104. A multi-bit control word can be applied to the programmable frequency generator 110 to affect the clock period. For instance, an external source such as the electronic controller can apply a five-bit control word to the programmable frequency generator to selectively adjust the clock period to one of up to thirty-two different available clock periods. In this example, the amount of delay provided with the delay circuits 104 to the fire signal 108 can be adjusted with the multi-bit control word applied to the programmable frequency generator 110.

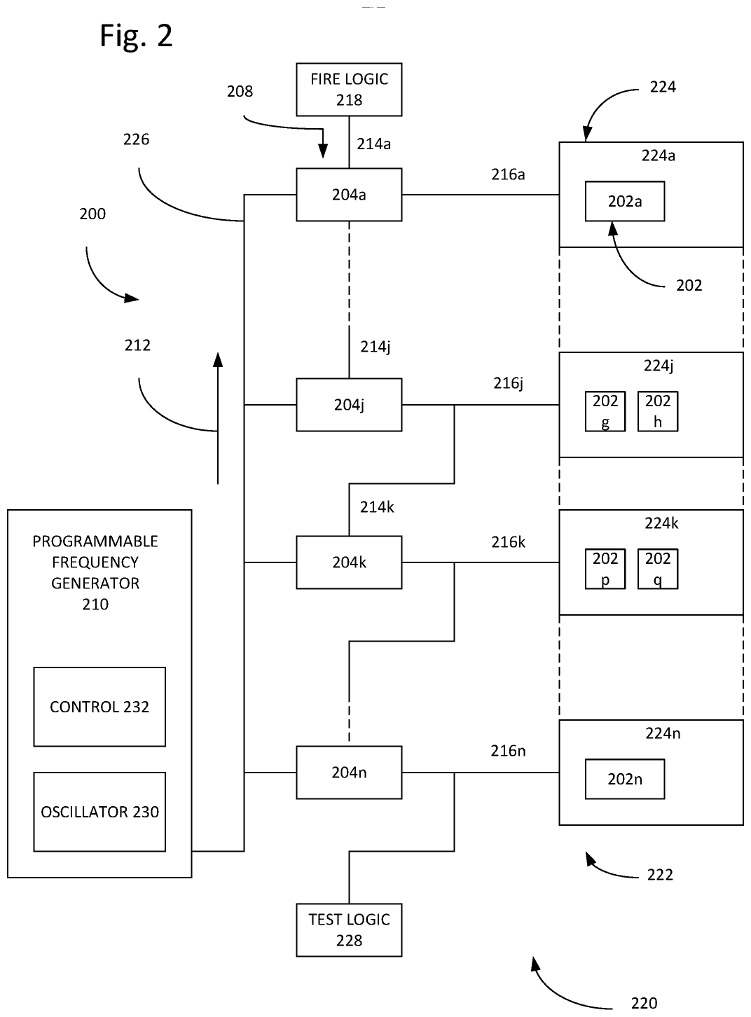

FIG. 2 illustrates an example fluid ejection device 200 that can implement the example integrated circuit 100. One example of a fluid ejection device 200 can include a printhead system such as a printhead cartridge for a printing device. The printhead system can include an integrated printhead (IPH), such as a printhead integrated with a container of print substance, or the printhead system can include a printhead integrated with a printing device. Examples of the fluid ejection device 200 described with reference to a printhead system for ejecting a print substance are for illustration. The fluid ejection device 200 includes a plurality of fluid actuators 202, and an integrated circuit having a plurality of delay circuits 204 with an on-die programmable frequency generator 210. The plurality of fluid actuators 202, plurality of delay circuits 204, and the programmable frequency generator 210 can be included on a fluid ejection die 220 of the fluid ejection device 200. The fluid ejection device 200 can include the plurality of actuators 202 arranged as an actuator device 222 along a column of the fluid ejection die 220. In one example, the plurality of actuators 202 of the actuator device 222 can be configured to eject a print substance of a single color, such as a black print substance, and operably coupled to a print substance reservoir, which may be included on the fluid ejection device 200. The fluid ejection device 200 may include a plurality of dice in which each die is configured to eject a print substance from a set of print substances, such as print substances of a subtractive color space, and each die of the plurality of dice can be operably coupled to a print substance reservoir of a plurality of print substance reservoirs, which may be included on the fluid ejection device 200.

The plurality of delay circuits 204 are configured to drive the plurality of fluid actuators 202 with a fire signal 208, which triggers a firing event in the fluid actuators 202 to eject a fluid such as a print substance. Each of the fluid actuators 202a . . . 202n corresponds with a delay circuit 204a . . . 204n, and each fluid actuator 202a . . . 202n is configured to receive the fire signal 208 from the corresponding delay circuit 204a . . . 204n. In one example, the number of fluid actuators 202 may be different than the number of delay circuits 204. For instance, the number of fluid actuators 202 may be greater than the number of delay circuits 204, and a delay circuit 204 may correspond with a plurality of fluid actuators of the plurality of fluid actuators 202. The plurality of delay circuits 204 are also coupled together in series to pass the fire signal 208 from one delay circuit to another delay circuit. The fire signal 208 is locally delayed at each delay circuit 204 as it is passed through the plurality of delay circuits 204 in series. The programmable frequency generator 210 provides a clock signal 212, having parameters such as a clock frequency and a clock period, to each of the plurality of delay circuits 204 to locally control an amount of delay of the fire signal 208 as the fire signal 208 is passed through the delay circuits 204. In one example, the programmable frequency generator 210 can be operably coupled to the delay circuits 204 via line 226 to provide clock signal 212.

Each delay circuit 204a . . . 204n can receive an input waveform on an input line and, after a delay, produce an output waveform on an output line. The delay circuits 204 are coupled together in series such that an output line of a delay circuit of a sequence is linked to the input line of a successive delay circuit of the sequence. The output waveform of each delay circuit 204a . . . 204n is similar to the input waveform of the delay circuit but is locally delayed by a selected amount of time as controlled by the clock signal 212. In the illustration, the plurality of delay circuits 204 include first delay circuit 204j and second delay circuit 204k coupled together in series in a sequence. First delay circuit 204j includes a first input line 214j and first output line 216j. Second delay circuit 204k includes a second input line 214k and a second output line 216k. Second input line 214k is coupled to first output line 216j such that the second delay circuit 204k receives an input waveform provided as the output waveform from the first delay circuit 204j. An initial delay circuit 204a in the sequence includes an initial input line 214a operably coupled to a fire logic circuit 218, which can provide a fire signal 208 on input line 214a, and the fire signal 208 is sequentially passed through the delay elements 204 to a final output line 216n of a final delay circuit 204n. In one example, the fire logic circuit 218 includes a conductive coupling such as a conductive pad to receive the fire signal 208 from an external, or off-die, source such as the controller. In an example in which the delay circuit 204 is a D flip-flop, the input lines 214 can be coupled to the D input and the output lines can be coupled to the output Q. The D flip flop also includes a clock input, which is coupled to line 226 to receive the clock signal 210.

The programmable frequency generator 210 in one example can include an electronic oscillator 230 and a control circuit 232. The electronic oscillator circuit 230 generates the clock signal having a frequency or period as selected by the control circuit 232. In one example, the electronic oscillator 230 is an RC oscillator or a ring oscillator. The electronic oscillator 230 includes analog elements that can produce a clock signal 212 susceptible to variations of clock period due to combinations of voltage, temperature, or silicon process speed. The control circuit 232 can provide a selected control signal, such as a control voltage V_{CTRL}, or a plurality of control voltages such as V_{CP} and V_{CN} to the electronic oscillator 230 to affect the clock period or clock frequency of the clock signal 212. The control circuit 232 provides the selected control voltage from a programmable input. In one example, the programmable frequency generator 210 includes a digital-to-analog converter to receive the programmable input and to generate a corresponding control signal as a set of continuous control voltages to affect parameters of the electronic oscillator 230. In one example, the digital-to-analog converter is a five-bit digital-to-analog converter that can receive a five-bit digital signal or control word as the programmable input and output one of up to thirty-two control voltage outputs, such as one of thirty-two control voltages V_{CTRL} or one of thirty-two sets of control voltages V_{CP} and V_{CN} to control the frequency or clock period of the electronic oscillator 230. In another example, the programmable input can be provided directly to the elements of the electronic oscillator 230, such as to enable P-channel or N-channel devices as a resistance selector in an RC delay circuit of the electronic oscillator 230, rather than convert the programmable input to an analog voltage.

In one example, the final output line 216n is coupled to test logic circuit 228. The test logic circuit 228 can receive the fire signal from the final delay circuit 204n and determine the total amount of delay of the fire signal 208 through the plurality of delay circuits 204. For example, the test logic circuit 228 can be coupled to the fire logic circuit 218 both directly and through the sequence of delay circuits 204, and the fire signals received from each coupling can be compared to determine the total amount of delay of the fire signal provided through the plurality of delay circuits 204. The total amount of delay can be measured and adjusted by programming the programmable frequency generator 210 to adjust the clock signal 212. In one example, the programmable input to the programmable frequency generator 210 can be selected to compensate for variations of the clock signal due to voltage, temperature, and process. In another example, the programmable input to the programmable frequency generator 210 to select a delay amount in each delay circuit 204 or to select the total amount of delay based on application of the fluid ejection device 200. For instance, the programmable frequency generator 210 can adjust the total amount of delay from between 1 microseconds to 5 microseconds, and an appropriate total amount of delay can be selected based on a factor such as a print mode speed of the ejection device 200. The total amount of delay can be selected to be short enough to allow the final delay circuit 204n to output a fire signal before a new fire signal is provided to the initial delay circuit 204a. Also, the total amount of delay can be selected to be long enough so that few delay circuits 204a . . . 204n are simultaneously outputting fire signals 208 to the fluid actuators 202 to reduce peak currents from firing events. The total amount of delay can also be selected based on other factors such as rate of change of current per time, or ∂i/∂t. For example, longer delays can reduce peak currents that can decrease the rate of change of current per time, which can reduce current supply droop and electrical noise in the fluid ejection die 220.

Each fluid actuator 202a . . . 202n is operably coupled to the output line 216a . . . 216n of a corresponding delay circuit 204a . . . 204n. In the illustrated example, a plurality of fluid actuators, such as fluid actuators 202g and 202h, are operably coupled to an output line of a corresponding delay circuit, such as output line 216j of delay circuit 204j. Also in the illustrated example, fluid actuators 202p and 202q are operably coupled to output line 216k of delay circuit 204k.

The plurality of actuators 202 can be arranged into a plurality of actuator primitives, or primitives 224, on the actuator device 222. For example, a selected number of proximate fluid actuators, such as fluid actuators 202g, 202h, can comprise a primitive 224j of the plurality of primitives 224. Primitive 224k can include fluid actuators 202p, 202q. The plurality of primitives 224 may be arranged along an axis of the column of the die 220 as primitives 224a to 224n. Each actuator 202 in a primitive 224 is assigned an address. In one example, each primitive 224 may include sixteen proximate fluid actuators 202 and the sixteen fluid actuators 202 on each primitive 224 can each be assigned an address from 0x0 to 0xF. In one example, one actuator 202 of a primitive 224 is selected at a time for ejecting a fluid as determined by the address. A controller can select the address and provide it to the primitives 224. (The controller can be located on the fluid ejection device 200 or can be remote from the fluid ejection device and provide a signal to the fluid ejection device 200 to select the address.) In one example, the selected address is applied to each primitive 224 on the actuator device 222. In this example, each delay circuit 204a . . . 204n corresponds with a primitive 224a . . . 224n, and each output line 216a . . . 216n of a corresponding delay circuit 204a . . . 204n is operably coupled to the corresponding primitive 224a . . . 224n. For instance, each output line 216a . . . 216n of a corresponding delay circuit 204a . . . 204n is operably coupled to the fluid actuators 202 comprising the corresponding primitive 224a . . . 224n. A fire signal 208 provided on the output line 216a . . . 216n triggers a firing event in a fluid actuator 202 of the corresponding primitive 224 as selected by the address. In another example, a delay circuit 204a . . . 204n can correspond with each Nth primitive 224a . . . 224n.

The fire signal 208 can be provided to the initial delay circuit 204a and passed through the plurality of delay circuits 204 and provided to primitives 224 to trigger firing events in the fluid actuators 202 corresponding with a selected address. For example, a fire signal 208 can be provided to input line 214j and delay circuit 204j can locally delay the fire signal 208 and provide the fire signal 208 on output line 216j to primitive 224j. In this example, a controller can select an address assigned to fluid actuator 202g of primitive 224j. Upon receiving the fire signal 208 at primitive 224j, a firing event is triggered in fluid actuator 202g to eject fluid from fluid actuator 202g. The fire signal 208 provided on output line 216j is also provided to input line 214k, and delay circuit 204k can locally delay the fire signal 208 and provide the fire signal 208 on output line 216k to primitive 224k. In this example, a controller can select an address assigned to fluid actuator 202p of primitive 224k. Upon receiving the fire signal 208 at primitive 224k, a firing event is triggered in fluid actuator 202p to eject fluid from fluid actuator 202p. In this example, after the fire signal 208 has been output from the final delay circuit 204n, the controller can select another address (such as the next address in sequence) and another fire signal can be provided to the initial delay circuit 204a and passed through the plurality of delay circuits 204 and provided to primitives 224.

Firing events in the primitives 224 are staggered as the fire signal 208 is passed through the sequence of delay circuits 204, and peak currents are reduced compared to simultaneously firing all primitives. The amount of peak current consumed in the die 220 can be selected by adjusting the amount of delay in the delay circuits 204 with the programmable frequency generator 210. A long delay relatively reduces peak currents and a short delay relatively increases peak currents in the die 220 during the firing events.

FIG. 3 illustrates an example printing device 300 that can employ the fluid ejection device 200 or integrated circuit 100. Printing device 300 includes a fluid ejection device, such as a printhead cartridge 302, which can be constructed in accordance with fluid ejection device 200 and include integrated circuit 100. Printhead cartridge 302 includes a fluid ejection die 304 to eject a print substance for printing or marking on media. The fluid ejection die 304 can be constructed in accordance with die 220. In one example, the printhead cartridge 302 includes a plurality of fluid ejection dice to eject a plurality of print substances, such as a print substances having color in the subtractive color space and a black print substance. The printing device 300 can include a print substance reservoir 306 to store and provide the print substance to the printhead cartridge 302. In one example, the print substance reservoir 306 can be included as part of the printhead cartridge 302. In another example, the print substance reservoir 306 can be remote from the printhead assembly 302 and may be operably coupled to the printhead cartridge 302 via tubing, valves, or pumps. In some examples, the print substance reservoir 306 can include a refillable reservoir that may be filled with a print substance from a print substance supply.

Printing device 300 includes a controller 310 operably coupled to the printhead cartridge 302. The controller 310 can include a combination of hardware and programming such as firmware stored on a memory device. The controller 310 can receive signals regarding a file, such as a digital document, to be printed, and provide signals to the printhead cartridge 302. In one example, portions of the controller 310 can be distributed on hardware or programming throughout the printing device, and portions of the controller 310 can be included on printhead cartridge 302. In one example, the controller 310 can incorporate features of fire logic circuit 218 and test logic circuit 228. The controller 310 can provide signals to the actuator device 222 regarding address of fluid actuators 202, can provide the fire signal 208 to the delay circuits 204, and can provide signals to the programmable frequency generator 210 to select a frequency or clock period for the clock signal 212. In one example, the controller 310 can receive signals from the delay circuits 204 to determine the status and health of components of the printhead cartridge 302. In one example, the printhead cartridge 302 can include conductive pads configured to mate with conductors on the printing device 300 such that the controller 310, or portions of the controller 310, can communicate with a printhead cartridge 302 that can be removably coupled to the printing device 300.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1-15. (canceled)

16. An integrated circuit to drive a plurality of fluid actuators, the integrated circuit comprising:
a plurality of delay circuits operably coupled in series and to a fire input to receive a fire signal in succession, each delay circuit to receive the fire signal and, after a delay, provide the fire signal via an output to a corresponding fluid actuator of the plurality of fluid actuators; and
a programmable frequency generator operably coupled to each of the plurality of delay circuits, the programmable frequency generator to provide a clock signal having an adjustable frequency to control the delay.

17. The integrated circuit of claim 16 wherein each delay circuit includes a flip-flop receiving the fire signal and the clock signal.

18. The integrated circuit of claim 16 wherein the programmable frequency generator includes a digital-to-converter to receive a programmable input to generate the clock signal.

19. The integrated circuit of claim 18 wherein the programmable input selects the frequency of the clock signal.

20. The integrated circuit of claim 16 wherein the frequency is selected from a plurality of available frequencies of the clock signal.

21. The integrated circuit of claim 16 wherein each delay circuit includes a fire signal input, and the output of a delay circuit of the plurality of delay circuits is coupled to the fire signal input of a successive delay circuit coupled in series.

22. The integrated circuit of claim 16 wherein a length of the delay is adjustable based on the clock signal.

23. The integrated circuit of claim 16 wherein the integrated circuit is included on a fluid ejection die.

24. A fluid ejection device, comprising:
a plurality of delay circuits operably coupled in series and to a fire input to receive a fire signal in succession, each delay circuit to receive the fire signal and, after a delay, provide the fire signal via an output;
a programmable frequency generator operably coupled to each of the plurality of delay circuits, the programmable frequency generator to provide a clock signal having an adjustable frequency to control the delay; and
a fluid actuator device having a plurality of fluid actuators, the fluid actuator device operably coupled to each output and to eject fluid with a fluid actuator of the plurality of the fluid actuators in response to the fire signal.

25. The fluid ejection device of claim 24 wherein the plurality of delay circuits, the programmable frequency generator, and the fluid actuator device are included on a fluid ejection die.

26. The fluid ejection device of claim 25 comprising a plurality of fluid ejection dice.

27. The fluid ejection device of claim 25 comprising a print substance reservoir.

28. A printhead comprising an integrated circuit to drive a plurality of fluid actuators, the integrated circuit comprising:
a plurality of delay circuits operably coupled in series and to a fire input to receive a fire signal in succession, each delay circuit to receive the fire signal and, after a delay, provide the fire signal to a corresponding fluid actuator of the plurality of fluid actuators;
a programmable frequency generator operably coupled to each of the plurality of delay circuits, the programmable frequency generator to provide a clock signal having an adjustable frequency to control the delay; and
a plurality of fluid actuators, each of the plurality of fluid actuators operably coupled to a corresponding output and to eject fluid in response to the fire signal.

29. The printhead of claim 28 wherein the plurality of fluid actuators are arranged in a plurality of primitives, and each primitive is coupled to a corresponding output.

30. The printhead of claim 29 wherein the plurality of primitives are arranged on a fluid ejection die along an axis of a column of the fluid ejection die.
